(19) United States
(12) Patent Application Publication
(10) Pub. No.: US 2026/0231969 A1
(43) Pub. Date: Aug. 13, 2026

(54) FLAVORED OR SWEETENED MILK COMPOSITIONS

(71) Applicant: RISE'N'SHINE FOOD & BEVERAGE LLC (dba JUBILEE'S FLAVORED MILK), Lakeway, TX (US)

(72) Inventor: Dana Ashley VERRILL, Lakeway, TX (US)

(21) Appl. No.: 19/258,168

(22) Filed: Jul. 2, 2025

Related U.S. Application Data
(60) Provisional application No. 63/758,098, filed on Feb. 13, 2025.

(51) Int. Cl. A23C 9/156; A23B 11/13; A23C 9/158; A23G 1/46; B65B 55/14

(52) U.S. Cl. CPC A23C 9/1565; A23B 11/13; A23C 9/158; A23G 1/46; B65B 55/14

(57) ABSTRACT

Described herein are flavored milk products. In one embodiment the flavored milk comprises one or more juices, extracts, or purees from one or more fruits or vegetables. In another aspect, the flavored milk contains no added processed sugar.

### CROSS-REFERENCE TO RELATED APPLICATIONS

This application claims priority to U.S. Provisional Patent Application No. 63/758,098, filed on Feb. 13, 2025, which is incorporated by reference herein in its entirety.

### BACKGROUND

Bovine milk is a source of nutrients for children and adults. Milk products constitute a significant portion of the overall diet or calorie consumption of human beings. As such, milk products play a major role in maintaining the health of the public. Nutritionally optimal milk products will have a positive effect on the nutrition and the health of the public.

Bovine milk contains 87% water, 3% protein, 0.65% whey, 4.5% to 5.0% lactose, 3% to 4% milk fat, 0.3% to 0.7% mineral salt plus a variety of water- and fat-soluble vitamins, lactic and citric acids, urea, free amino acids, and polypeptides. One or more of these components may be separated from milk to produce various compositions. For example, milk fat can be removed as cream and the casein fraction of the milk is then precipitated at its isoelectric point by the addition of acid. The remainder of the original milk, containing all of the other components listed above, is called whey i.e., milk, from which the casein and a majority of the milk fat has been removed.

Various flavors are often added to make milk more attractive and palatable to children. Current flavored milk products often add processed sugar to sweeten the milk. This adds unnecessary calories.

What is needed are favored or sweetened milk products that have improved tastes but lack added processed sugar and are healthy for children.

### SUMMARY

One embodiment described herein is a favored or sweetened milk composition comprising: at least 94% by mass of milk; and 0.5-6% of one or more juices, extracts, or purees from one or more fruits or vegetables. In one aspect, the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof. In another aspect, the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof. In another aspect, the milk comprises human, cow, sheep, goat, buffalo, camel, llama, mare, or deer milk. In another aspect, the milk comprises cow milk. In another aspect, the composition does not contain any added processed sugars or syrups or artificial sweeteners.

Another embodiment described herein is a method for sweetening or flavoring milk, the method comprising: combining milk and one or more juices, extracts, or purees from one or more fruits or vegetables to form a mixture; homogenizing the mixture; and packaging the mixture.

Another embodiment described herein is a favored or sweetened milk composition comprising: milk; one or more juices, extracts, or purees from one or more fruits or vegetables; and organic or natural flavors. In another aspect, the composition comprises:
greater than about 94% by mass milk; about 0.5-6% one or more juices, extracts, or purees from one or more fruits or vegetables; and about 0.1-1.0% by mass of organic and natural flavors. In one aspect, the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof. In another aspect, the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof. In another aspect, the milk comprises human, cow, sheep, goat, buffalo, camel, llama, mare, or deer milk. In another aspect, the milk comprises cow milk. The favored or sweetened milk composition of claim 13, wherein the milk is organic whole milk. In another aspect, the composition does not contain any added processed sugars or syrups or artificial sweeteners. In another aspect, the composition further comprises organic gums, salts, and processing additives. In another aspect, the composition comprises: about 94-98% by mass of milk; about 0.5-6% one or more juices, extracts, or purees from one or more fruits or vegetables; about 0.1-1.0% by mass of organic and natural flavors; about 0.1-0.2% by mass of organic vitamins; about 0.08-0.4% by mass of one or more organic gums; and about 0.1-1.0% by mass of salts. In another aspect, the flavors comprise, chocolate, strawberry, vanilla, banana, or combinations thereof. In another aspect, the chocolate flavored milk further comprises cocoa powder. In another aspect, the composition has a density of 1.01-1.05 g/mL; a pH of 6.5-7.0, and a Brix of 10-15.

Another embodiment described herein is a method for manufacturing a favored or sweetened milk composition, the method comprising: combining milk, vitamins, one or more juices, extracts, or purees from one or more fruits or vegetables, and other components forming a mixture; transferring the mixture into a feed tank; pumping the mixture into a tubular preheater at 82° C. (180° F.); transferring the preheated mixture to a tubular final heater and hold tube at 144° C. (290° F.); transferring the heated mixture to a tubular precooler at 82° C. (180° F.); homogenizing the precooled mixture at 2500 psi; transferring the homogenized precooled mixture to a final cooler 16° C. (60° F.); transferring the cooled mixture to a sterile tank; and filling product packaging. In one aspect, the mixture is sterilized and packaged in sterile containers.

Another embodiment described herein is a favored or sweetened milk made by the methods described herein.

Another embodiment described herein is a kit comprising: a favored or sweetened milk product; packaging; and a label comprising ingredients, nutritional information, and branding. In one aspect, the packaging is liquid-proof boxes, bottles, cans, or pouches.

### DESCRIPTION OF THE DRAWINGS

FIG. 1 shows a schematic for ultra-high temperature (UHT) processing to sterilize the flavored milk products described herein.

### DETAILED DESCRIPTION

Unless otherwise defined, all technical and scientific terms used herein have the same meaning as commonly understood by one of ordinary skill in the art. For example, any nomenclatures used in connection with, and techniques of food chemistry and manufacturing, biochemistry, and chemistry described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, terms such as “include,” “including,” “contain,” “containing,” “having,” and the like mean “comprising.” The present disclosure also contemplates other embodiments “comprising,” “consisting essentially of,” and “consisting of” the embodiments or elements presented herein, whether explicitly set forth or not. As used herein, “comprising,” is an “open-ended” term that does not exclude additional, unrecited elements or method steps. As used herein, “consisting essentially of” limits the scope of a claim to the specified materials or steps and those that do not materially affect the basic and novel characteristics of the claimed invention.

As used herein, “consisting of” excludes any element, step, or ingredient not specified in the claim. As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “and/or” refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to +10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “~” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to +10% of any value within the range or within 3 or more standard deviations, including the end points, or as described above in the definition of “about.”

As used herein, the terms “room temperature,” “RT,” or “ambient temperature” refer to the typical temperature in an indoor laboratory setting. In one aspect, the laboratory setting is climate controlled to maintain the temperature at a substantially uniform temperature or with a specific range of temperatures. In one aspect, “room temperature” refers a temperature of about 15-30° C., including all integers and endpoints within the specified range. In another aspect, “room temperature” refers a temperature of about 15-30° C.; about 20-30° C.; about 22-30° C.; about 25-30° C.; about 27-30° C.; about 15-22° C.; about 15-25° C.; about 15-27° C.; about 20-22° C.; about 20-25° C.; about 20-27° C.; about 22-25° C.; about 22-27° C.; about 25-27° C.; about 15° C.±10%; about 20° C.±10%; about 22° C.±10%; about 25° C.±10%; about 27° C.±10%; ~20° C., ~22° C., ~25° C., or ~27° C., at standard atmospheric pressure.

As used herein, the term “dairy products” or “dairy compositions” are those comprising one or more milk components. The complete nutritional milk compositions can be provided as unflavored milks, flavored milks, ice creams, yogurts, cheeses and any nutritional product that can be prepared from milk or milk components.

As used herein the term “milk” includes fat-free milk, low fat milk, full fat milk, lactose-free milk (produced by hydrolyzing the lactose by lactase enzyme to glucose and galactose, or other method), concentrated milk or dry milk.

Fat-free milk is nonfat or skim milk product. Low-fat milk is typically defined as milk that contains from about 1% to about 2% fat. Full fat milk often contains about 3.25% fat. As used herein, the term “milk” is also intended to encompass milks from animal and plant sources. Animal sources of milk include, but are not limited to, human, cow, sheep, goat, buffalo, camel, llama, mare, and deer. Plant sources of milk include, but are not limited to, milk extracted from soybean. In addition, the term “milk” refers to not only whole milk, but also skim milk or any liquid component derived therefrom. By “whey” is meant the milk component remaining after all or a substantial portion of the milk fat and casein contained in milk are removed.

As used herein, “favored or sweetened milk” refers to milk that contains one or more natural sweeteners or flavors to alter or enhance the taste of the milk. The favored or sweetened milk may contain one or more juices, extracts, or purees from one or more fruits or vegetables. The favored or sweetened milk may also contain vitamins, salts (such as sodium phosphate and/or sodium chloride), plant gums, and processing agents such as anti-foaming agents. In one aspect, all juices, extracts, or purees from one or more fruits or vegetables and flavors are organic and/or natural. In another aspect, the favored or sweetened milk does not contain any processed sugars such as high-fructose corn syrup, processed sugar (e.g., cane sugar, sucrose), or artificial sweeteners (e.g., aspartame, sucralose). In another aspect the milk is organic whole milk from cows.

As used herein “fruit” refers to any known fruit that could be used to make extracts, juices or purees. Exemplary and nonlimiting examples of fruits are apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee. Methods for preparing extracts, juices, or purees are known in the art and typically involve macerating the fruit and extracting the juice, extract or puree.

As used herein “vegetable” refers to any known vegetable that could be used to make extracts, juices or purees. Exemplary and nonlimiting examples of vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof. Methods for preparing extracts, juices, or purees are known in the art and typically involve macerating the vegetable and extracting the juice, extract or puree.

As used herein “vitamins” refers to retinol (A), thiamine (B1), riboflavin (B2), niacinamide (B3), pantothenic acid (B5), pyridoxamine (B6), biotin (B7), folic acid (B9) cobalamin (B12), ascorbic acid (C), cholecalciferol (D), tocopherol (E), phylloquinone (K), choline, inositol, lipoic acid, or para-aminobenzoic acid, among others.

Other additives that may be added to the compositions include amino acids, including alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, and salts thereof; salts of sodium, potassium, magnesium, calcium, ammonium, phosphate, carbonate, or sulfate; trace elements including iron, manganese, copper, iodine, zinc, cobalt, fluoride, chromium, molybdenum, selenium, nickel, silicon, vanadium, salts thereof, or combinations thereof.

As used herein “flavored” refers to altering or enhancing the flavor of the composition by the additional natural flavorings. Flavors include vanilla, chocolate, coffee, caramel, butterscotch, citrus (lemon, orange, lime, grapefruit etc.), berry (e.g., strawberry, cherry, blueberry, raspberry, blackberry, etc.), fruity (apple, peach, pear) mint, cinnamon, tropical flavors (pineapple, coconut, florals), nutty (peanut, hazelnut, almond, etc.), pumpkin spice, eggnog, savory/umami flavors, or combinations thereof. Natural or organic compounds are preferred as flavorings.

As used herein “sweetened” refers to altering or enhancing the sweetness of the composition by adding natural compositions to increase the sweetness. Exemplary sweeteners include juices, extracts, or purees from fruits and vegetables. Processed sugars, high fructose corn syrup, and artificial sweeteners are not used as sweeteners.

The compositions may contain typical food additives to enhance the organoleptic properties, texture, viscosity, stabilize the formulation, improve storage properties, and enhance manufacturing. Typical additives include starches and gums, pH stabilizers, acids, bases, emulsifiers, anti-foaming agents, anti-oxidants, or preservatives among others. Natural additives are preferred.

The compositions described herein may be colored with natural (non-artificial) food dyes and colorants to enhance the appearance.

One embodiment described herein is a favored or sweetened milk composition comprising: at least 94% by mass of milk; and 0.5-6% of one or more juices, extracts, or purees from one or more fruits or vegetables. In one aspect, the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof. In another aspect, the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof. In another aspect, the milk comprises human, cow, sheep, goat, buffalo, camel, llama, mare, or deer milk. In another aspect, the milk comprises cow milk. In another aspect, the composition does not contain any added processed sugars or syrups or artificial sweeteners.

Another embodiment described herein is a method for sweetening or flavoring milk, the method comprising: combining milk and one or more juices, extracts, or purees from one or more fruits or vegetables to form a mixture; homogenizing the mixture; and packaging the mixture.

Another embodiment described herein is a favored or sweetened milk composition comprising: milk; one or more juices, extracts, or purees from one or more fruits or vegetables; and organic or natural flavors. In another aspect, the composition comprises:
greater than about 94% by mass milk; about 0.5-6% one or more juices, extracts, or purees from one or more fruits or vegetables; and about 0.1-1.0% by mass of organic and natural flavors. In one aspect, the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof. In another aspect, the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof. In another aspect, the milk comprises human, cow, sheep, goat, buffalo, camel, llama, mare, or deer milk. In another aspect, the milk comprises cow milk. In another aspect, the milk is organic whole milk. In another aspect, the composition does not contain any added processed sugars or syrups or artificial sweeteners. In another aspect, the composition further comprises organic gums, salts, and processing additives. In another aspect, the composition comprises: about 94-98% by mass of milk; about 0.5-6% one or more juices, extracts, or purees from one or more fruits or vegetables; about 0.1-1.0% by mass of organic and natural flavors; about 0.1-0.2% by mass of organic vitamins; about 0.08-0.4% by mass of one or more organic gums; and about 0.1-1.0% by mass of salts. In another aspect, the flavors comprise, chocolate, strawberry, vanilla, banana, or combinations thereof. In another aspect, the chocolate flavored milk further comprises cocoa powder. In another aspect, the composition has a density of 1.01-1.05 g/mL; a pH of 6.5-7.0, and a Brix of 10-15.

Another embodiment described herein is a method for manufacturing a favored or sweetened milk composition, the method comprising: combining milk, vitamins, one or more juices, extracts, or purees from one or more fruits or vegetables, and other components forming a mixture; transferring the mixture into a feed tank; pumping the mixture into a tubular preheater at 82° C. (180° F.); transferring the preheated mixture to a tubular final heater and hold tube at 144° C. (290° F.); transferring the heated mixture to a tubular precooler at 82° C. (180° F.); homogenizing the precooled mixture at 2500 psi; transferring the homogenized precooled mixture to a final cooler 16° C. (60° F.); transferring the cooled mixture to a sterile tank; and filling product packaging. In one aspect, the mixture is sterilized and packaged in sterile containers.

Another embodiment described herein is a favored or sweetened milk made by the methods described herein.

Another embodiment described herein is a kit comprising: a favored or sweetened milk product; packaging; and a label comprising ingredients, nutritional information, and branding. In one aspect, the packaging is liquid-proof boxes, bottles, cans, or pouches.

It will be apparent to one of ordinary skill in the relevant art that suitable modifications and adaptations to the compositions, formulations, methods, processes, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any variations or iterations. The scope of the compositions, formulations, methods, and processes described herein include all actual or potential combinations of embodiments, aspects, options, examples, and preferences herein described. The exemplary compositions and formulations described herein may omit any component, substitute any component disclosed herein, or include any component disclosed elsewhere herein. The ratios of the mass of any component of any of the compositions or formulations disclosed herein to the mass of any other component in the formulation or to the total mass of the other components in the formulation are hereby disclosed as if they were expressly disclosed. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:
Clause 1. A favored or sweetened milk composition comprising:
   at least 94% by mass of milk; and
   0.5-6% of one or more juices, extracts, or purees from one or more fruits or vegetables.
Clause 2. The favored or sweetened milk composition of clause 1, wherein the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof.
Clause 3. The favored or sweetened milk composition of clause 1 or 2, wherein the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof.
Clause 4. The favored or sweetened milk composition of any one of clauses 1-3, wherein the milk comprises human, cow, sheep, goat, buffalo, camel, llama, mare, or deer milk.
Clause 5. The favored or sweetened milk composition of any one of clauses 1-4, wherein the milk comprises cow milk.
Clause 6. The favored or sweetened milk composition of any one of clauses 1-5, wherein the composition does not contain any added processed sugars or syrups or artificial sweeteners.
Clause 7. A method for sweetening or flavoring milk, the method comprising:
   combining milk and one or more juices, extracts, or purees from one or more fruits or vegetables to form a mixture;
   homogenizing the mixture; and
   packaging the mixture.
Clause 8. A favored or sweetened milk composition comprising:
   milk;
   one or more juices, extracts, or purees from one or more fruits or vegetables; and
   organic or natural flavors.
Clause 9. The favored or sweetened milk composition of clause 8, wherein the composition comprises:
   greater than about 94% by mass milk;
   about 0.5-6% one or more juices, extracts, or purees from one or more fruits or vegetables; and
   about 0.1-1.0% by mass of organic and natural flavors.
Clause 10. The favored or sweetened milk composition of clause 8 or 9, wherein the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof.
Clause 11. The favored or sweetened milk composition of any one of clauses 8-10, wherein the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof.
Clause 12. The favored or sweetened milk composition of any one of clauses 8-11, wherein the milk comprises human, cow, sheep, goat, buffalo, camel, llama, mare, or deer milk.
Clause 13. The favored or sweetened milk composition of any one of clauses 8-11, wherein the milk comprises cow milk.
Clause 14. The favored or sweetened milk composition of any one of clauses 8-13, wherein the milk is organic whole milk.
Clause 15. The favored or sweetened milk composition of any one of clauses 8-14, wherein the composition does not contain any added processed sugars or syrups or artificial sweeteners.
Clause 16. The favored or sweetened milk composition of any one of clauses 8-16, wherein the composition further comprises organic gums, salts, and processing additives.
Clause 17. The favored or sweetened milk composition of any one of clauses 8-17, wherein the composition comprises:
   about 94-98% by mass of milk;
   about 0.5-6% one or more juices, extracts, or purees from one or more fruits or vegetables;
   about 0.1-1.0% by mass of organic and natural flavors;
   about 0.1-0.2% by mass of organic vitamins;
   about 0.08-0.4% by mass of one or more organic gums; and
   about 0.1-1.0% by mass of salts.
Clause 18. The favored or sweetened milk composition of any one of clauses 8-17, wherein the flavors comprise, chocolate, strawberry, vanilla, banana, or combinations thereof.
Clause 19. The favored or sweetened milk composition of any one of clauses 8-18, wherein the chocolate flavored milk further comprises cocoa powder.
Clause 20. The favored or sweetened milk composition of any one of clauses 8-19 wherein the composition has a density of 1.01-1.05 g/mL; a pH of 6.5-7.0, and a Brix of 10-15.
Clause 21. A method for manufacturing a favored or sweetened milk composition, the method comprising:
   combining milk, vitamins, one or more juices, extracts, or purees from one or more fruits or vegetables, and other components forming a mixture;
   transferring the mixture into a feed tank;
   pumping the mixture into a tubular preheater at 82° C. (180° F.);
   transferring the preheated mixture to a tubular final heater and hold tube at 144° C. (290° F.);
   transferring the heated mixture to a tubular precooler at 82° C. (180° F.);
   homogenizing the precooled mixture at 2500 psi;
   transferring the homogenized precooled mixture to a final cooler 16° C. (60° F.);
   transferring the cooled mixture to a sterile tank; and
   filling product packaging.
Clause 22. The method of clause 21, wherein the mixture is sterilized and packaged in sterile containers.
Clause 23. Favored or sweetened milk made by the method of clause 7 or 21.
Clause 24. A kit comprising:
   a favored or sweetened milk product;
   packaging; and
   a label comprising ingredients, nutritional information, and branding.
Clause 25. The kit of clause 24, wherein the packaging is liquid-proof boxes, bottles, cans, or pouches.

### EXAMPLES

### Example 1

Flavored milk products were prepared by combining dry ingredients in milk and mixing until dissolved. Fruit juices, fruit juice concentrates, and fruit purees were added and mixed. Flavors were added last.

TABLE 1
General Flavored Milk Composition

| Ingredient | Mass Percentage Range (%) |
|---|---|
| Organic Milk | 94-98 |
| Organic Vitamin C | 0.1-0.2 |
| Organic Vitamin D3 | 0.001-0.005 |
| Organic Fruit Extract | 0.005-0.2 |
| Organic Fruit Juice | 0.5-5 |
| Organic Fruit Puree | 0.0-1 |
| Organic Gums | 0.08-0.4 |
| Disodium Phosphate | 0.1-1.0 |
| Organic and Natural Flavors | 0.1-1.0 |
| Anti foam | 0.001-0.01 |
| Total | 100.0 |

A chocolate chip flavored milk was prepared according to Table 2.

TABLE 2
Chocolate Chip Cookie Flavored Milk

| Ingredient | Mass Percent (%) |
|---|---|
| Organic Milk | 96.6 |
| Organic Vitamin C | 0.2 |
| Organic Vitamin D3 | 0.0 |
| Organic Monk Fruit Extract | 0.1 |
| Arabic Gum | 0.2 |
| Disodium Phosphate | 0.1 |
| Sea Salt | 0.1 |
| Cocoa Powder | 0.5 |
| Carrot Juice Concentrate | 1.7 |
| Cookie Flavor | 0.3 |
| Butter Flavor | 0.1 |
| Chocolate Flavor | 0.2 |
| Anti foam | 0.005 |
| Total | 100.0 |

The blended product had the following specifications:
Product Density (at 21.5° C.): 1.032 g/mL (8.612 lbs/gal)
pH: 6.85±0.30
Brix: 12.90±0.20
Taste: Chocolate Chip
Appearance: Light Brown

A strawberry vanilla flavored milk was prepared according to Table 3.

TABLE 3
Strawberry Vanilla Flavored Milk

| Ingredient | Mass Percent (%) |
|---|---|
| Organic Milk | 94.7 |
| Organic Vitamin C | 0.1 |
| Organic Vitamin D3 | 0.0 |
| Organic Monk Fruit Extract | 0.0 |
| Arabic Gum | 0.2 |
| Disodium Phosphate | 0.6 |
| Strawberry Juice Concentrate | 2.0 |
| Beet Juice | 2.0 |
| Organic Strawberry Flavor | 0.3 |
| Organic Vanilla Flavor | 0.2 |
| Anti foam | 0.0 |
| Total | 100.0 |

The blended product had the following specifications:
Product Density (at 21.5° C.): 1.041 g/mL (8.687 lbs/gal)
pH: 6.74±0.30
Brix: 15.6±0.20
Taste: Strawberry Vanilla Milk
Appearance: Light Pink

A banana vanilla flavored milk was prepared according to Table 4.

TABLE 4
Banana Vanilla Flavored Milk

| Ingredient | Mass Percent (%) |
|---|---|
| Organic Milk | 96.6 |
| Organic Vitamin C | 0.2 |
| Organic Vitamin D3 | 0.0 |
| Organic Monk Fruit Extract | 0.0 |
| Arabic Gum | 0.2 |
| Disodium Phosphate | 0.1 |
| Sea Salt | 0.0 |
| Banana Puree | 0.5 |
| Carrot Juice Concentrate | 1.7 |
| Turmeric Powder | 0.1 |
| Organic Banana Flavor | 0.2 |
| Organic Vanilla Flavor | 0.1 |
| Flavor enhancer | 0.3 |
| Anti foam | 0.0 |
| Total | 100.0 |

The blended product had the following specifications:
Product Density (at 21.5° C.): 1.035 g/mL (8.637 lbs/gal)
pH: 6.81±0.30
Brix: 14.8±0.20
Taste: Banana Vanilla Milk
Appearance: Yellow

### Example 2

### Product and Batching Information

The product was batched according to the supplied instructions using a Tetra Pak High Shear Mixing system. Batch 1 size was about 100 gallons (400 kg; 379 L) and Batch 2 size was reduced to 70 gallons (280 kg; 265 L) due to ingredient shortages. Pasteurized milk was used for all batching. Once the product mixture was assembled, it was tested for pH and solids, then sent to the processor for sterilization.

### Thermal Processing

The Tetra Pak Aseptic FLEX processing system was used for the UHT process. The system consists of standard monotube heat exchangers for the preheat, final heat, precool, and final cooling stages. A total of 8 loops were used in the preheating and precooling stages, and 10 loops were used in the final heat and final cooling stages. The downstream homogenizers were set at 2000/500 psi (2500 psi total) to ensure consistent particle size and homogeneous product.

The FDA-filed minimum process for the products was ~140° C. (282° F.) for 5.33 seconds, calculated using laminar flow. This process yields a minimum Fₒ of 5.0 for the products. The actual temperature in the hold tube was set around 143° C. (290° F.), and hold time slightly longer than the minimum, to avoid thermal process deviations and replicate commercial processing conditions. After the hold tube, the product was precooled to about 82° C. (180° F.), and then final cooled to about 16-21° C. (60-70° F.) and sent to an aseptic tank.

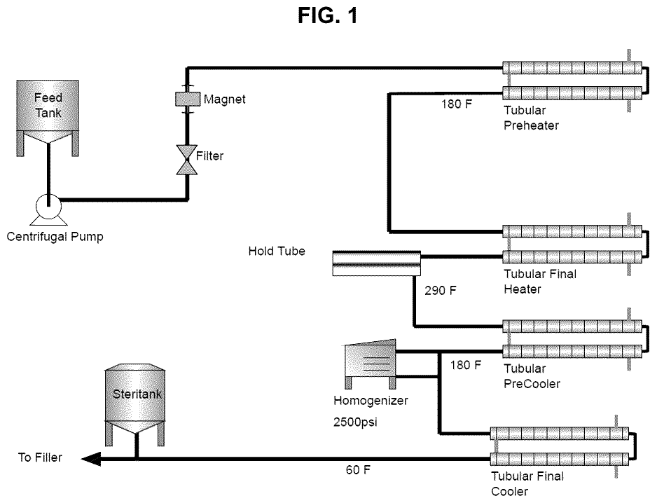

Data is shown in Table 5 and process flow diagram is shown in FIG. 1.

TABLE 5
Flavored Milk Process Analyses

| | | |
|---|---|---|
| Banana | Strawberry | Chocolate |
| Vanilla | Vanilla | Chip Cookie |

Blending Observations

| | | | |
|---|---|---|---|
| Blending Viscosity/Temp/75° F./cps | 21.20 | 21.50 | 22.00 |
| Next Day Cooled Viscosity/Temp/44° F. | 28.30 | 25.20 | 26.20 |
| Processed Viscosity/temp 70 F. | 19.80 | 18.40 | 19.20 |
| pH Before Processing | 6.74 | 6.89 | 6.67 |
| pH After Processing | 6.72 | 6.80 | 6.66 |
| Product Specific Gravity (Density) 70° F. | 1.033 | 1.035 | 1.038 |
| Product Total Solids % (raw) | 13.52 | 14.26 | 13.78 |
| Product Total Solids % (processed) | 12.77 | 13.70 | 13.18 |

Processing System

| | | | |
|---|---|---|---|
| Microthermics (Steam Injection) | Yes | Yes | Yes |
| Unitherm (Tubular) | — | — | — |

Processing Specifications

| | | | |
|---|---|---|---|
| Pre-heat Temperature | 46° C. (185° F.) | 46° C. (185° F.) | 48° C. (190° F.) |
| Processing Temperature (hold tube) | 70-71° C. | 70-71° C. | 70-71° C. |
| | (282.7-283.8° F.) | (282.2-283.9° F.) | (286.7-287.1° F.) |
| Post Homogenization Pressure (psi) | 1500/500 | 1500/500 | 1500/500 |
| Post Homogenization Temperature | 44-45° C. | 44-45° C. | 44-45° C. |
| | (178-180° F.) | (178-180° F.) | (178-180° F.) |
| Filling Temperature | 17.5-19° C. | 17.5-19° C. | 17.5-19° C. |
| | (70-75° F.) | (70-75° F.) | (70-75° F.) |

### Packaging

The product was packaged using a Tetra Pak A3 Compact Flex filling machine in 330 ml Tetra Prisma packages using Tetra Brik Aseptic/jl type packaging material. The packaging machine ran smoothly, and 501 packages were produced in the first run and 236 packages were produced for the second. Nitrogen was utilized for headspace in all batches.

### Quality Analysis

Random and targeted samples were taken for Quality analysis. The packages were incubated for 14 days at 33° C. (90° F.). A sample of 36 packages were analyzed using traditional plating media. All packages are tested for pH and visually inspected. For full details, see the Quality Data in attached data table. Based on the data, the products were considered “Commercially Sterile.” Color, scent, and texture all appeared normal. Normal package integrity was performed (teardown, electrolytic, and red dye) with no issues observed.

### SUMMARY

The batch testing went well from a batching, processing, and packaging standpoint. A total of two individual batches were attempted and successfully packaged. There was no build up in the hold tube, indicating the product was reasonably heat stable.

What is claimed:

1. A favored or sweetened milk composition comprising:
at least 94% by mass of milk; and
0.5-6% of one or more juices, extracts, or purees from one or more fruits or vegetables.

2. The favored or sweetened milk composition of claim 1, wherein the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof.

3. The favored or sweetened milk composition of claim 1, wherein the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof.

4. The favored or sweetened milk composition of claim 1, wherein the milk comprises human, cow, sheep, goat, buffalo, camel, llama, mare, or deer milk.

5. The favored or sweetened milk composition of claim 1, wherein the milk comprises cow milk.

6. The favored or sweetened milk composition of claim 1, wherein the composition does not contain any added processed sugars or syrups or artificial sweeteners.

7. A method for sweetening or flavoring milk, the method comprising:
combining milk and one or more juices, extracts, or purees from one or more fruits or vegetables to form a mixture;
homogenizing the mixture; and
packaging the mixture.

8. A favored or sweetened milk composition comprising:
milk;
one or more juices, extracts, or purees from one or more fruits or vegetables; and
organic or natural flavors.

9. The favored or sweetened milk composition of claim 8, wherein the composition comprises:
greater than about 94% by mass milk;
about 0.5-6% one or more juices, extracts, or purees from one or more fruits or vegetables; and
about 0.1-1.0% by mass of organic and natural flavors.

10. The favored or sweetened milk composition of claim 8, wherein the one or more fruits comprise apple, pear, peach, nectarine, apricot, plum, grape, cherry, avocado, strawberry, raspberry, blueberry, blackberry, gooseberry, boysenberry, pomegranate, watermelon, cantaloupe, honeydew, canary, crenshaw, orange, tangerine, grapefruit, lime, lemon, pomelo, banana, pineapple, kiwi, papaya, mango, guava, passion fruit, Monk fruit, coconut, crane, Korean melon, rambutan, jackfruit, durian, mangosteen, carambola, lychee, cherimoya, currant, carambola, fig, date, ackee, or combinations thereof.

11. The favored or sweetened milk composition of claim 8, wherein the one or more vegetables comprise carrots, beets, parsnips, asparagus, celery, radishes, turnips, potatoes, sweet potatoes, yams, arugula, bok choy, cabbage, collard greens, kale, lettuce, spinach, Swiss chard, artichokes, broccoli, brussels sprouts, cabbage, cauliflower, beans, peas, corn, cucumbers, pumpkin, tomatoes, tomatillo, peppers, eggplant, fennel, okra, garlic, leeks, onions, shallots, scallions, squash, zucchini, Daikon, bitter melon, romanesco, purslane, cactus, sugar cane, ginger, aloe, agave, jicama, mint, cilantro/coriander, parsley, dill, oregano, or combinations thereof.

12. The favored or sweetened milk composition of claim 8, wherein the milk comprises human, cow, sheep, goat, buffalo, camel, llama, mare, or deer milk.

13. The favored or sweetened milk composition of claim 8, wherein the milk comprises cow milk.

14. The favored or sweetened milk composition of claim 13, wherein the milk is organic whole milk.

15. The favored or sweetened milk composition of claim 8, wherein the composition does not contain any added processed sugars or syrups or artificial sweeteners.

16. The favored or sweetened milk composition of claim 8, wherein the composition further comprises organic gums, salts, and processing additives.

17. The favored or sweetened milk composition of claim 8, wherein the composition comprises:
about 94-98% by mass of milk;
about 0.5-6% one or more juices, extracts, or purees from one or more fruits or vegetables;
about 0.1-1.0% by mass of organic and natural flavors;
about 0.1-0.2% by mass of organic vitamins;
about 0.08-0.4% by mass of one or more organic gums; and
about 0.1-1.0% by mass of salts.

18. The favored or sweetened milk composition of claim 8, wherein the flavors comprise, chocolate, strawberry, vanilla, banana, or combinations thereof.

19. The favored or sweetened milk composition of claim 18, wherein the chocolate flavored milk further comprises cocoa powder.

20. The favored or sweetened milk composition of claim 8, wherein the composition has a density of 1.01-1.05 g/mL; a pH of 6.5-7.0, and a Brix of 10-15.

21. A method for manufacturing a favored or sweetened milk composition, the method comprising:
combining milk, vitamins, one or more juices, extracts, or purees from one or more fruits or vegetables, and other components forming a mixture;
transferring the mixture into a feed tank;
pumping the mixture into a tubular preheater at 82° C. (180° F.);
transferring the preheated mixture to a tubular final heater and hold tube at 144° C. (290° F.);
transferring the heated mixture to a tubular precooler at 82° C. (180° F.);
homogenizing the precooled mixture at 2500 psi;
transferring the homogenized precooled mixture to a final cooler 16° C. (60° F.);
transferring the cooled mixture to a sterile tank; and
filling product packaging.

22. The method of claim 21, wherein the mixture is sterilized and packaged in sterile containers.

23. Favored or sweetened milk made by the method of claim 21.

24. A kit comprising:
a favored or sweetened milk product;
packaging; and
a label comprising ingredients, nutritional information, and branding.

25. The kit of claim 24, wherein the packaging is liquid-proof boxes, bottles, cans, or pouches.
